(19) United States
(12) Patent Application Publication
(10) Pub. No.: US 2009/0242183 A1
(43) Pub. Date: Oct. 1, 2009

(54) COMPRESSION ROLLER, APPARATUS FOR MANUFACTURING HEAT EXCHANGER TUBE HAVING THE SAME AND HEAT EXCHANGER TUBE

(76) Inventors: Jong-Seo Yoon, Gyeonggi-do (KR); Youn-Hak Shin, Gyeonggi-do (KR)

Correspondence Address: JONES DAY, 222 EAST 41ST ST, NEW YORK, NY, 10017, US

(21) Appl. No.: 12/407,925

(22) Filed: Mar. 20, 2009

(30) Foreign Application Priority Data
Mar. 27, 2008 (KR) 10-2008-0028561

(51) Int. Cl. F28F 1/00; B23P 15/26; B21B 15/00; B21B 1/08

(52) U.S. Cl. 165/181; 29/890.053; 72/206; 72/252.5

(57) ABSTRACT

An apparatus for manufacturing a heat exchanger tube includes an extruding means for extruding an aluminum preform in the shape of a tube; and a pair of compression rollers, each provided above and below the aluminum tube for compressing a central portion of the aluminum tube in the lengthwise direction of the aluminum tube, and having a disc-like shape.

The present invention can process a heat exchanger tube without changing the shape of a die of the extruding means. As a result, excessive stress that may be applied to the die is prevented, and a heat exchanger tube is manufactured safely. And, an integrated two parallel-row tube with a connection portion according to the present invention provides simple assembly of a heat exchanger and a larger heat radiation area to increase a heat radiation efficiency.

### FIELD OF THE INVENTION

The present invention relates to an apparatus for manufacturing a heat exchanger tube, and in particular, to a compression roller capable of fine-processing a heat exchanger tube without changing the shape of a die of an extruding means, and an apparatus for manufacturing a heat exchanger tube having the same and a heat exchanger tube.

### BACKGROUND OF THE INVENTION

A heat exchanger tube is one of components of an automotive heat exchanger, and is made of aluminum in consideration of light weight, high sensitivity and heat conductivity characteristics. The heat exchanger tube is mounted in a heat exchanger of transportation means such as automobiles and provides high efficiency heat exchange, leading to reduction in fuel consumption of the transportation means.

Typically, a heat exchanger tube for an automotive heat exchanger is referred to as a PFC (Parallel Flow Condenser) tube and is manufactured by extruding an aluminum wire in the shape of a tube. A conventional process for manufacturing a heat exchanger tube is described with reference to FIGS. 1 and 2.

Referring to FIGS. 1 and 2, first, a raw material for a heat exchanger tube, i.e. an aluminum preform 1 is fed from a first bobbin 10, chemically treated by an impurity removing means 20 to remove impurities from the surface thereof, and transferred to an extruding means 30.

Then, the aluminum preform 1 is extruded by the extruding means 30 into an aluminum tube 40 having a plurality of channels 41, through which a cooling medium flows. Subsequently, the surface of the aluminum tube 40 is zinc-coated by a thermal spraying means 50. The aluminum tube 40 is fed to a caterpillar 60, guided to a second bobbin 80 by a guide roller 70, and wound on the second bobbin 80. As mentioned above, the process for manufacturing a heat exchanger tube is completed.

In the manufacture of a heat exchanger, the aluminum heat exchanger tubes are assembled with pins. In particular, the heat exchanger tubes are arranged in two parallel rows and bonded to the pins in a heating furnace. A bonding material cladded on either the heat exchanger tubes or the pins is melted in the heating furnace, and provides adhesion between the heat exchanger tubes and the pins.

According to the conventional process, two heat exchanger tubes are arranged in two parallel rows and assembled together. For easier assembly, a die of an extruding means may be modified to simultaneously extrude two heat exchanger tubes in two parallel rows. However, if the die of the extruding means is modified to provide a tube arrangement of two parallel rows, excessive stress occurs to the die, resulting in destroy of the die. For this reason, in most cases, the above-mentioned conventional process is still used.

Meanwhile, the important characteristics of a heat exchanger tube is heat radiation and light weight. That is why aluminum is used to manufacture the heat exchanger tube. Aluminum has excellent heat conductivity and light weight.

The heat radiation efficiency is closely related to area of a medium for radiating heat. As an area of the medium for radiating heat increases, heat radiation effect increases, and vice versa. However, a heat exchanger tube should be installed at a limited space of a heat exchanger. Thus, an increase in area of the heat exchanger tube results in a limited increase in heat radiation effect.

### SUMMARY OF THE INVENTION

The present invention is designed to solve the above-mentioned problems. Therefore, it is an object of the present invention to provide a compression roller capable of fine-processing a heat exchanger tube without changing the shape of a die of an extruding means, and an apparatus for manufacturing a heat exchanger tube having the same and a heat exchanger tube.

In order to achieve the object of the present invention, an apparatus for manufacturing a heat exchanger tube according to the present invention includes an extruding means for extruding an aluminum perform of a heat exchanger tube in the shape of a tube; and a pair of compression rollers, each provided above and below the aluminum tube for compressing a central portion of an aluminum tube extruded by the extruding means in the lengthwise direction of the aluminum tube, and having a disc-like shape.

In the present invention, the compression roller has a plurality of rectangular protrusions spaced apart from each other along an outer periphery thereof, and a width of the protrusion is smaller than a width of the outer periphery of the compression roller.

In order to achieve the object of the present invention, a compression roller according to another aspect of the present invention is included an apparatus for manufacturing a heat exchanger tube having an extruding means for extruding an aluminum preform of a heat exchanger in the shape of a tube, and the compression roller includes an upper compression roller located above the aluminum tube and a lower compression roller located below the aluminum tube, is configured to compress a central portion of an aluminum tube extruded by the extruding means in the lengthwise direction of the aluminum tube, and has a disc-like shape.

A heat exchanger tube according to the present invention includes a first tube having at least one channel formed therein; a second tube having at least one channel formed therein; and a connection portion formed between the first tube and the second tube for providing interconnection between the first tube and the second tube, wherein a thickness of the connection portion is smaller than a thickness of each of the first tube and the second tube.

### BRIEF DESCRIPTION OF THE DRAWINGS

The present invention will be more fully described in the following detailed description, taken accompanying drawings, however, the description proposed herein is just a preferable example for the purpose of illustrations, not intended to limit the scope of the invention.

FIG. 1 is a schematic view of a conventional apparatus for manufacturing a heat exchanger tube.

FIG. 2 is a perspective view of a conventional heat exchanger tube.

FIG. 3 is a schematic view of an apparatus for manufacturing a heat exchanger tube according to the present invention.

FIG. 4 is a view of a compression roller of the apparatus for manufacturing a heat exchanger tube according to the present invention, viewed from the front and side.

FIGS. 5A and FIGa 5B are schematic front cross-sectional views of a heat exchanger tube before and after compression by the compression roller according to the present invention, respectively.

FIG. 6 is a view of a compression roller of the apparatus for manufacturing a heat exchanger tube according to another aspect of the present invention, viewed from the front and side.

FIG. 7 is a perspective view of a heat exchanger tube compressed by the compression roller according to another aspect of the present invention.

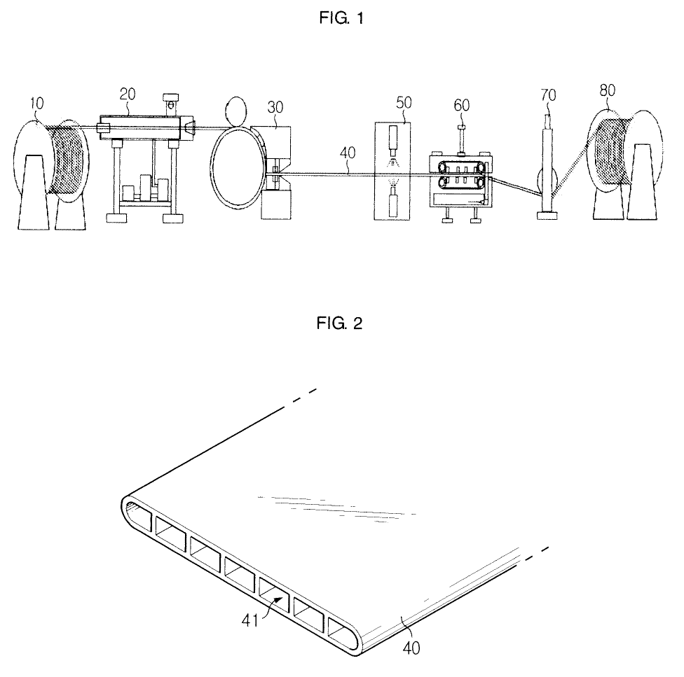

### DETAILED DESCRIPTION OF THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

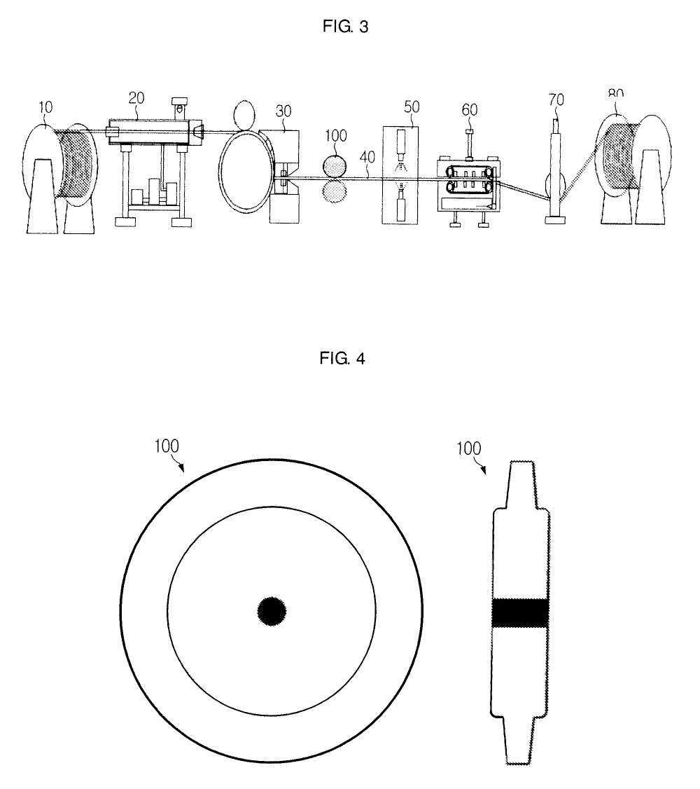

FIG. 3 is a schematic view of an apparatus for manufacturing a heat exchanger tube according to the present invention.

Referring to FIG. 3, the apparatus for manufacturing a heat exchanger tube includes a first bobbin 10, an impurity removing means 20, an extruding means 30, a zinc thermal spraying means 50, a caterpillar 60, a guide roller 70 and a second bobbin 80. These elements are typical elements of an apparatus for manufacturing a heat exchanger tube well known in the art and they are mentioned in the background of the invention, and their description is omitted.

The apparatus for manufacturing a heat exchanger tube according to the present invention further includes a pair of compression rollers 100 for compressing a tube extruded by the extruding means 30. As shown in FIG. 3, each compression roller 100 is provided above and below the aluminum tube 40. As shown in FIG. 4, the compression roller 100 has a disc-like shape.

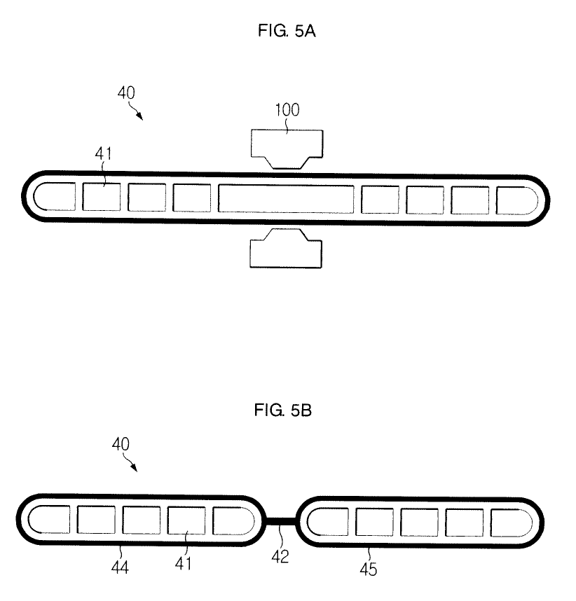

FIGS. 5A and FIG. 5B are schematic front cross-sectional views of a heat exchanger tube before and after compression by the compression roller 100 according to the present invention, respectively. Hereinafter, a process for manufacturing a heat exchanger tube according to the present invention is described with reference to FIGS. 3, 5A and 5B.

The extruding means 30 extrudes an aluminum preform in the shape of a tube 40 having a plurality of channels 41. The compression rollers 100 compress a central portion of the aluminum tube 40 extruded by the extruding means 30 (See FIG. 5A). As a result, the aluminum tube 40 has a first tube 44, a second tube 45, and a connection portion 42 interposed between the first tube 44 and the second tube 45. The aluminum tube 40 has such a shape that tubes arranged in two parallel rows are integrated into a single tube (See FIG. 5B). The aluminum tube 40 is passed through the zinc thermal spraying means 50, the caterpillar 60 and the guide roller 70, and is wound on the second bobbin 80.

The connection portion 42 is configured to radiate heat transferred from a cooling or heating medium flowing through the first tube 44 and the second tube 45. As mentioned above, heat radiation efficiency is closely related to heat radiation area. The apparatus for manufacturing a heat exchanger tube according to the present invention forms the connection portion 42 in the heat exchanger tube to increase a heat radiation area, and consequently increase a heat radiation efficiency in comparison with a conventional process for manufacturing a heat exchanger tube that simply arranges individual tubes in two parallel rows.

A heat exchanger tube manufactured by the apparatus for manufacturing a heat exchanger tube according to the present invention is formed of an integrated two parallel-row tube by a single operation. Thus, the heat exchanger tube of the present invention has an increased productivity in comparison with a conventional heat exchanger tube that is manufactured one by one. And, in the case that the heat exchanger tube of the present invention is installed in a heat exchanger, the present invention has such an effect that tubes of two rows are simultaneously installed in a heat exchanger, thereby increasing simplicity of a tube installation operation.

Further, use of the compression rollers 100 eliminates the need to change the shape of the extruding means 30, in particular, a die of the extruding means 30. Thus, the present invention can prevent excessive stress from applying to the die and reduce the destroy of the die, thereby resulting in safe manufacturing of the heat exchanger tube.

Meanwhile, according to another aspect of the present invention, the compression roller 100 may have a plurality of protrusions 101 formed along an outer periphery thereof. The protrusions 101 are spaced apart from each other.

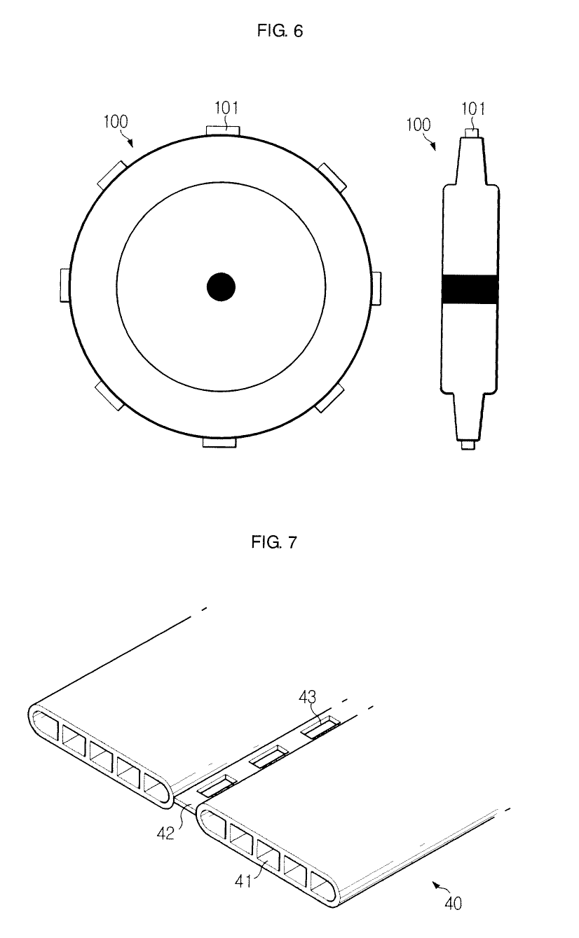

FIG. 6 is a view of a compression roller according to another aspect of the present invention, viewed from the front and side.

Referring to FIG. 6, the rectangular protrusions 101 are spaced apart from each other along the outer periphery of the compression roller 100. At this time, the compression roller 100 includes an upper compression roller located above the aluminum tube 40 and a lower compression roller located below the aluminum tube 40. The upper and lower compression rollers are aligned such that the rectangular protrusions 101 of the upper compression roller correspond to the rectangular protrusions 101 of the lower compression roller.

The compression roller 100 compresses a central portion of the aluminum tube 40 to form the connection portion 42. At the same time, the compression roller 100 forms through-holes in the connection portion 42 where the rectangular protrusions 101 of the upper and lower compression rollers are engaged with each other. That is, the through-holes are continuously formed in the connection portion 42 at intervals corresponding to the spaced intervals between the rectangular protrusions 101.

As shown in FIG. 7, a heat exchanger tube according to the present invention is manufactured by a single operation in the shape of a two parallel-row tube including the first tube 44, the second tube 45 and the connection portion 42. The connection portion 42 has through-holes 43. Accordingly, the heat exchanger tube shows reduction in weight of the aluminum tube 40 and increase in heat radiation area, consequently increase in heat radiation efficiency.

At this time, if the through-holes 43 are arranged in dense intervals, the heat exchanger tube has a poor durability. If the through-holes 43 are arranged in loose intervals, the heat exchanger tube becomes heavy. Therefore, the rectangular protrusions 101 should be spaced apart from each other at appropriate intervals to meet the light weight and durability requirements of the heat exchanger tube. It should be understood by persons having ordinary skills in the art that the present invention has various variations or modifications depending on tube size or design environment.

And, if a width of the rectangular protrusion 101 is larger than a width of the outer periphery of the compression roller 100, the heat exchanger tube may be damaged, resulting in reduction of usage life or impossibility of use. Therefore, preferably a width of the rectangular protrusion 101 is smaller than a width of the outer periphery of the compression roller 100.

Therefore, the present invention can process a heat exchanger tube without changing the shape of a die of an extruding means. As a result, excessive stress that may be applied to the die is prevented, and a heat exchanger tube is manufactured safely. And, an integrated two parallel-row tube with a connection portion according to the present invention provides simple assembly of a heat exchanger and a larger heat radiation area to increase a heat radiation efficiency.

Hereinabove, preferred embodiments of the present invention has been described in detail with reference to the accompanying drawings. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An apparatus for manufacturing a heat exchanger tube, comprising:
an extruding means for extruding an aluminum preform of a heat exchanger tube in the shape of a tube; and
a pair of compression rollers, each provided above and below the aluminum tube for compressing a central portion of an aluminum tube extruded by the extruding means in the lengthwise direction of aluminum tube, and having a disc-like shape.

2. The apparatus for manufacturing a heat exchanger tube according to claim 1,
wherein the compression roller has a plurality of rectangular protrusions spaced apart from each other along an outer periphery thereof.

3. The apparatus for manufacturing a heat exchanger tube according to claim 2,
wherein a width of the protrusion is smaller than a width of the outer periphery of the compression roller.

4. A compression roller of an apparatus for manufacturing a heat exchanger tube, the apparatus comprising an extruding means for extruding an aluminum perform of a heat exchanger tube in the shape of a tube,
wherein the compression roller includes an upper compression roller located above the aluminum tube and a lower compression roller located below the aluminum tube, is configured to compress a central portion of an aluminum tube extruded by the extruding means in the lengthwise direction of the aluminum tube, and has a disc-like shape.

5. The compression roller of an apparatus for manufacturing a heat exchanger tube according to claim 4,
wherein the compression roller has a plurality of rectangular protrusions spaced apart from each other along an outer periphery thereof.

6. The compression roller of an apparatus for manufacturing a heat exchanger tube according to claim 5,
wherein a width of the protrusion is smaller than a width of the outer periphery of the compression roller.

7. A heat exchanger tube, comprising:
a first tube having at least one channel formed therein;
a second tube having at least one channel formed therein; and
a connection portion formed between the first tube and the second tube for providing interconnection between the first tube and the second tube,
wherein a thickness of the connection portion is smaller than a thickness of each of the first tube and the second tube.

8. The heat exchanger tube according to claim 7,
wherein the connection portion has a plurality of through-holes formed along the lengthwise direction of the tubes.
